(19) United States
(12) Patent Application Publication
(10) Pub. No.: US 2025/0142636 A1
(43) Pub. Date: May 1, 2025

(54) RANDOM ACCESS PROCEDURE OPTIMIZATION FOR ENERGY HARVESTING SDT DEVICES

(71) Applicant: Nokia Technologies Oy, Espoo (FI)

(72) Inventors: Alberto MARTINEZ-ALBA, Munich (DE); Rakash SIVASIVA GANESAN, Unterhaching (DE); Halit Murat GURSU, Munich (DE); Nitin MANGALVEDHE, Hoffman Estates, IL (US); Rapeepat RATASUK, Inverness, IL (US)

(21) Appl. No.: 18/722,458

(22) PCT Filed: Dec. 21, 2021
(86) PCT No.: PCT/US2021/073043

§ 371 Date: Jun. 20, 2024

(51) Int. Cl. H04W 74/0833

(52) U.S. Cl. CPC H04W 74/085

(57) ABSTRACT

A network node may determine a congestion level of a random access channel; and may transmit, to one or more energy constrained user equipments, at least one barring parameter, wherein the at least one barring parameter may be based, at least partially, on the determined congestion level and an energy constraint of the one or more user equipments. An energy constrained user equipment may receive a system information block comprising a barring factor and a back-off time; may determine whether to transmit a preamble for a random access procedure based, at least partially, on the barring factor and a maximum number of preamble transmission attempts; may transmit the preamble based on a determination to do so, or may wait for the back-off time based on a determination to not do so.

### TECHNICAL FIELD

The example and non-limiting embodiments relate generally to massive machine-type communications (mMTC) and Internet of Things (IoT) and, more particularly, to mMTC energy constraints.

### BACKGROUND

It is known, in mMTC, to perform small data transmission (SDT) or early data transmission (EDT) to save device energy.

### SUMMARY

The following summary is merely intended to be illustrative. The summary is not intended to limit the scope of the claims.

In accordance with one aspect, an apparatus comprising: at least one processor; and at least one memory including computer program code; the at least one memory and the computer program code configured to, with the at least one processor, cause the apparatus at least to: determine a congestion level of a random access channel; and transmit, to one or more user equipments, at least one barring parameter, wherein the at least one barring parameter is based, at least partially, on the determined congestion level and an energy constraint of the one or more user equipments, wherein the one or more user equipments comprise one or more energy-constrained user equipments.

In accordance with one aspect, a method comprising: determining a congestion level of a random access channel; and transmitting, to one or more user equipments, at least one barring parameter, wherein the at least one barring parameter is based, at least partially, on the determined congestion level and an energy constraint of the one or more user equipments, wherein the one or more user equipments comprise one or more energy-constrained user equipments.

In accordance with one aspect, an apparatus comprising means for performing: determining a congestion level of a random access channel; and transmitting, to one or more user equipments, at least one barring parameter, wherein the at least one barring parameter is based, at least partially, on the determined congestion level and an energy constraint of the one or more user equipments, wherein the one or more user equipments comprise one or more energy-constrained user equipments.

In accordance with one aspect, a non-transitory computer-readable medium comprising program instructions stored thereon which, when executed with at least one processor, cause the at least one processor to: determine a congestion level of a random access channel; and cause transmission, to one or more user equipments, at least one barring parameter, wherein the at least one barring parameter is based, at least partially, on the determined congestion level and an energy constraint of the one or more user equipments, wherein the one or more user equipments comprise one or more energy-constrained user equipments.

In accordance with one aspect, an apparatus comprising: at least one processor; and at least one memory including computer program code; the at least one memory and the computer program code configured to, with the at least one processor, cause the apparatus at least to: receive a system information block, wherein the system information block comprises, at least, a barring factor and a back-off time; determine whether to transmit a preamble for a random access procedure based, at least partially, on the barring factor and a maximum number of preamble transmission attempts; based on a determination to transmit the preamble for the random access procedure, transmit the preamble; and based on a determination to not transmit the preamble for the random access procedure, wait for the back-off time and receive a further system information block.

In accordance with one aspect, a method comprising: receiving a system information block, wherein the system information block comprises, at least, a barring factor and a back-off time; determining whether to transmit a preamble for a random access procedure based, at least partially, on the barring factor and a maximum number of preamble transmission attempts; based on a determination to transmit the preamble for the random access procedure, transmitting the preamble; and based on a determination to not transmit the preamble for the random access procedure, waiting for the back-off time and receive a further system information block.

In accordance with one aspect, an apparatus comprising means for performing: receiving a system information block, wherein the system information block comprises, at least, a barring factor and a back-off time; determining whether to transmit a preamble for a random access procedure based, at least partially, on the barring factor and a maximum number of preamble transmission attempts; based on a determination to transmit the preamble for the random access procedure, transmitting the preamble; and based on a determination to not transmit the preamble for the random access procedure, waiting for the back-off time and receive a further system information block.

In accordance with one aspect, a non-transitory computer-readable medium comprising program instructions stored thereon which, when executed with at least one processor, cause the at least one processor to: receive a system information block, wherein the system information block comprises, at least, a barring factor and a back-off time; determine whether to transmit a preamble for a random access procedure based, at least partially, on the barring factor and a maximum number of preamble transmission attempts; based on a determination to transmit the preamble for the random access procedure, cause transmitting of the preamble; and based on a determination to not transmit the preamble for the random access procedure, wait for the back-off time and receive a further system information block.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a flowchart illustrating steps as described herein;

FIG. 3 is a diagram illustrating features as described herein;

FIG. 4 is a diagram illustrating features as described herein;

FIG. 5 is a diagram illustrating features as described herein;

FIG. 6 is a diagram illustrating features as described herein;

FIG. 7 is a flowchart illustrating steps as described herein;

FIGS. 8a-c are graphs illustrating features as described herein;

FIGS. 9a-b are graphs illustrating features as described herein;

FIGS. 10a-b are graphs illustrating features as described herein;

FIGS. 11a-b are graphs illustrating features as described herein;

FIG. 12 is a flowchart illustrating steps as described herein; and

FIG. 13 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
ACB access class barring
AMF access and mobility management function
CU central unit
DU distributed unit
EDT early data transmission
EH energy harvesting
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
IoT Internet of Things
L1 layer 1
LTE long term evolution
MAC medium access control
MME mobility management entity
mMTC massive machine-type communications
ng or NG new generation
ng-eNB or NG-eNB new generation eNB
NR new radio
N/W or NW network
PDCP packet data convergence protocol
PHY physical layer
RAN radio access network
RAO random access opportunity
RAP random access procedure
RF radio frequency
RLC radio link control
RRC radio resource control
RRH remote radio head
RS reference signal
RU radio unit
Rx receiver
SDAP service data adaptation protocol
SDT small data transmission
SGW serving gateway
SIB system information block
SMF session management function
Tx transmitter
UE user equipment (e.g., a wireless, typically mobile device)
UAC unified access control
UPF user plane function

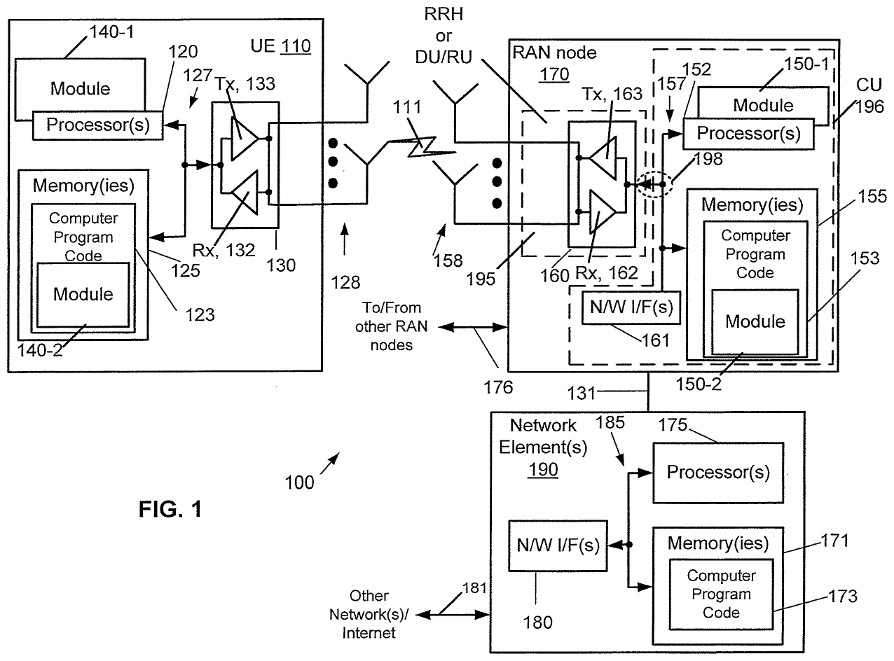

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link (s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Features as described herein generally relate to massive machine-type communications (mMTC) and Internet of Things (IoT). An objective of 5G radio access networks is to provide reliable connectivity to massive machine-type deployments. These deployments may consist of hundreds or thousands of small, low-energy devices, which may exhibit requirements and traffic behaviors that differ substantially from that of conventional human-type devices. This is leading to the redesign of multiple aspects of current radio access networks, which are tailored to human customers and hence may not be appropriate for mMTC.

Apart from their large numbers, mMTC devices are usually constrained by the power they can consume. This has resulted in multiple innovations oriented to saving power by removing unnecessary transmission, leveraging sleep periods, or optimizing resource usage. One such innovation is Small Data Transmission (SDT) or Early Data Transmission (EDT), in which devices are allowed to transmit small pieces of data in their very first opportunities, without the need for properly establishing or resuming a data connection. This drastically reduces the transmission overhead, hence reducing overall power consumption. Nonetheless, SDT entails some disadvantages, such as the use of a reduced set of dedicated preambles during the random access phase, which may lead to collision probabilities. For small or randomized networks, this disadvantage may not be a major problem. Nonetheless, mMTC devices may be numerous and, specially, they may tend to simultaneously transmit owing to periodic reports, alarm events, etc. Thus, random access may be an important obstacle when trying to transmit with very low power.

In addition, in recent years a new type of mMTC devices started to gain momentum: energy-harvesting (EH) devices. In contrast to battery-powered devices, these devices collect their energy from the environment, by means of solar cells, mechanical generators, radiofrequency harvesters, etc. Although all low-power mMTC devices share similar characteristics and requirements, energy-harvesting devices have some special requirements. For example, since the battery charge may decrease and increase randomly over time, long-term operation may not be as critical as for charge-decreasing, battery-powered devices (i.e. non-EH devices). Instead, energy-harvesting devices may struggle at collecting/harvesting/saving enough energy for short active periods, even though they may eventually recover from full battery drainage. In an example embodiment of the present disclosure, a random access procedure may take into account these special characteristics of EH devices.

Devices supporting SDT have access to dedicated random access resources, which are indeed a subset of all the available random access resources. This may lead to high probabilities of collisions and retransmission in the case of simultaneous transmissions of multiple devices. Although random access procedures have been optimized in the state of the art for battery-powered devices, thus focusing on long-term battery optimization, energy-harvesting devices may exhibit suboptimal performance if these procedures are applied. For example, an energy harvesting device may experience failure during random access procedure (RAP) due to their need to harvest energy between transmissions. In other words, an EH device may have insufficient energy to complete a random access procedure.

An EH device may also be referred to as a device having an energy constraint, i.e. an energy-constrained device. An energy-constrained device, such as a UE, may be an energy harvesting UE, or a UE with a low batter capacity, or a passive UE with no battery that works with, for example, backscattering. The energy constraint may be UE battery level, capacity, harvesting capacity, backscattering capability, etc.

The time between successive transmissions, or the expected duration of a random access procedure, is defined for legacy devices. Energy-harvesting devices may not be able to harvest enough energy between two successive transmissions, or before the start and the completion of random access procedures. Not having enough energy for a transmission, or for the completion of the random access procedure, may result in unexpected behavior, i.e., EH UE not being able to transmit a message even if the specifications enforce/require it to do so. This may cause radio link or beam failures, or QoS issues, for an EH UE; these conditions should be strictly avoided.

From TR 38.840 “Study of UE power saving in NR (Release 16)”, we know that a UE consumes 250 to 700 times more power when transmitting on the UL with Tx power 1 mW to 200 mW, respectively, when compared to a deep sleep state. A simple calculation yields that the power consumption when transmitting ranges between 110 mW (20 mW Tx power) and 310 mW (200 mW Tx power), and the power consumption in deep sleep is 450 μW.

A single preamble transmission takes 1 ms (unless we use numerologies with higher subcarrier spacings). This implies an energy consumption of 110 μJ to 310 μJ. After each transmission, the UE needs to be prepared to wait for the duration of the contention resolution timer, which takes between 8 ms to 64 ms (this is broadcast in the system information). According to TR 38.840, the UE consumes 100 times more power when listening to PDCCH with respect to deep sleep, that is, 45 mW. This implies an energy consumption due to waiting for contention resolution of 360 μJ to 2.9 mW. For simplicity, we assume that the contention resolution takes 16 ms, so 720 μJ. Therefore, the UE consumes approximately 1 mJ per Tx attempt. Finally, the UE needs to synchronize to the cell and get the MIB/SIB1 before being able to start transmitting. The SSB block is transmitted every 10 ms, so the maximum energy consumption of this phase is 450 μJ.

Out of the current alternatives for energy harvesting, solar power seems the most promising one. Small commercial solar cells (2 cm×2 cm) output a maximum power of 7.5 mW (0.5 V and 15 mA). Assuming an 80% efficiency of the DC-DC converter (which is rather optimistic) this results in 6 mW maximum available power. During cloudy days, the efficiency of the solar cell could drop to 10-30% of the maximum power. That is, 0.6 mW to 1.8 mW available power. Since in deep sleep the UE consumes 0.45 mW, this leaves 0.15 mW to 1.35 mW excess power that can be stored in the battery.

As a result, an EH UE needs to wait up to 10 seconds for accumulating enough energy to transmit once, and 6.6 seconds per additional transmission. Therefore, the UE may require up to 70 seconds of deep sleep to harvest enough energy to transmit 10 times. This periodicity may be larger than the time between transmission reports in a sensor network, for example.

Currently, the 5G Unified Access Control (UAC) implements a simple version of Access Class Barring (ACB), in which UEs belonging to a barred class use a network-configured barring factor to decide whether they are allowed to access the network (i.e. initiate the random access procedure). Information about the barring class, the barring factor, and the back-off time for those UEs not allowed to transmit are broadcast in the System Information Block 1 (SIB1), along with the cell access information and other relevant parameters.

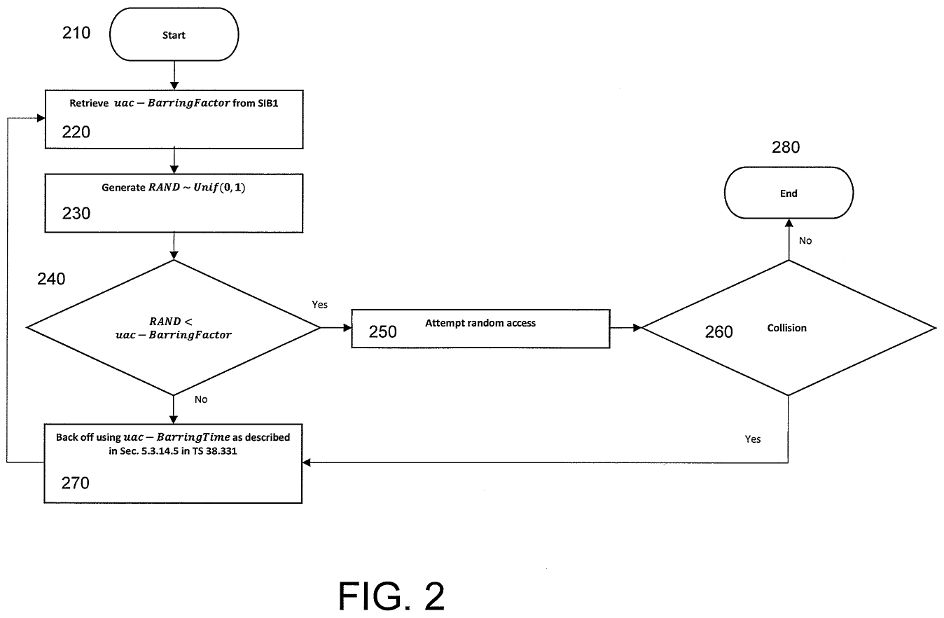

Referring now to FIG. 2, illustrated is a summarized example of operation of 5G UAC. Whenever a UE (of any type) intends to connect to the mobile network, it may first select a cell, synchronize, and retrieve system information from the Master Information Block (MIB) and the System Information Block 1 (SIB1) (210). From these information blocks, the UE may locate the random access channel and inform itself about the required parameters for network access.

In addition, the UE may observe whether it belongs to a barred class or not (220). If the UE belongs to a barred class, it may generate a random number RAND between 0 and 1 before attempting to initiate the random access procedure (230). This number may then be compared against uac-BarringFactor, which is included within SIB1 (240). Alternatively, the uac-BarringFactor may be included in a different SIB.

If a random number RAND<uac-BarringFactor (240), the UE may proceed with the random access procedure normally (250). Otherwise, the UE may generate a second random number RAND between 0 and 1 and use it to compute a random back-off time using uac-BarringTime, provided in SIB1, for example as described in Sec. 5.3.14.5 in TS 38.331 (270). In other words, the UE may not attempt to initiate the random access procedure; the UE may not transmit a random access preamble during a waiting period. After waiting for this back-off time, the UE may perform step 220 again, i.e. retrieving uac-BarringFactor from SIB1.

If the UE does not experience a collision in response to attempting random access (260), the UE may complete the random access procedure (280). If the UE does experience a collision (260), the UE may go to step 270, i.e. backing off using uac-BarringTime.

The emergence of energy-harvesting devices as a new mobile use case within mMTC deployments has attracted the attention of numerous researchers. In addition, owing to the unique challenges they may face during the random access procedure as a result of their limited, and random, battery levels, several works in the state of the art propose models to predict their behaviour. Examples of these works include Liu, Yan, et al. “RACH in Self-Powered NB-IoT Networks: Energy Availability and Performance Evaluation.” IEEE Transactions on Communications 69.3 (2020): 1750-1764; Amini, Mohammad Reza, and Mohammed W. Baidas. “Reliability-Latency Tradeoffs in Random Access Ultra-Reliable Low-Latency Energy-Harvesting 5G Networks with Finite Blocklength Codes.” 2020 IEEE 31st Annual International Symposium on Personal, Indoor and Mobile Radio Communications. IEEE, 2020; and Duan, Suyang, Vahid Shah-Mansouri, and Vincent W S Wong. “Dynamic access class barring for M2M communications in LTE networks.” 2013 IEEE Global Communications Conference (GLOBECOM). IEEE, 2013. In these works, the authors focus on modelling how energy-harvesting, energy-limited devices perform with current RAP. However, these current works only propose adjusting classic parameters of 5G UAC.

In example embodiments of the present disclosure, a new random access procedure setting may be introduced to the 5G RAN. A technical effect of example embodiments of the present disclosure may be to reduce the outage probabilities of energy-harvesting devices supporting SDT. In an example embodiment, this may be accomplished by adding new signaling and system information in the steps preceding the random access itself, along with modifications in the random access procedure.

It may be noted that example embodiments of the present disclosure focus on EH devices supporting SDT. However, example embodiments of the present disclosure are not limited to use with such devices; example embodiments may be applicable to other scenarios and devices as well.

In order to reduce outage probabilities of EH devices supporting SDT, do this, a series of technical challenges may have to be overcome. For example, a base station may need to estimate and monitor the congestion level or load of the random access channel. This information may need to be communicated to the energy-harvesting UEs that intend to transmit, but have not yet successfully connected to the network. Additionally, the energy-harvesting UEs may need to rely on an improved method to decide whether to transmit or to back off at every random access opportunity. A technical effect of implementation of a different method for determining whether to proceed with RAP may be to minimize outage probability (e.g. caused by not having enough power for the next transmission).

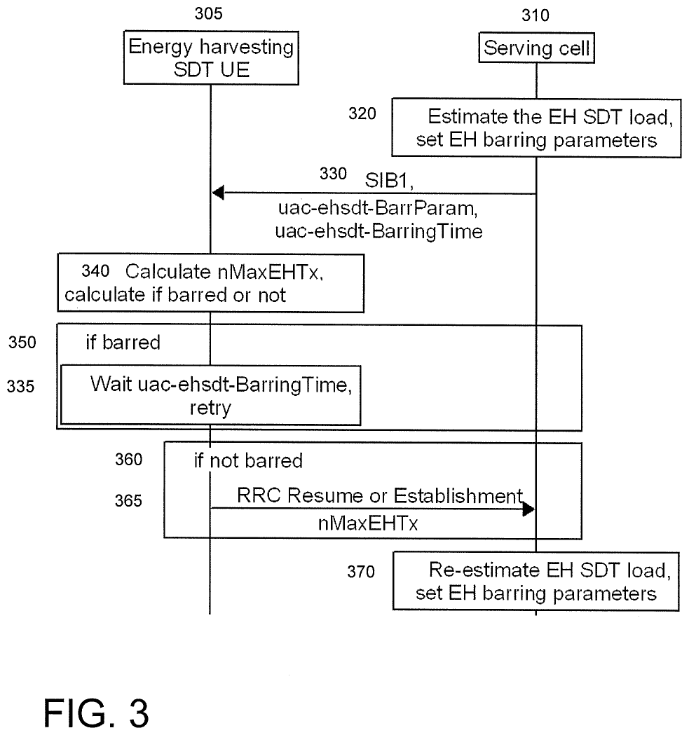

Referring now to FIG. 3, illustrated is a message sequence chart describing backlog estimation. At 320, the serving cell 310 may estimate the EH SDT load, and may set EH barring parameters based on the estimation. The EH barring parameters may be configured to maximize energy conservation and minimize delay for an EH device. The EH barring parameters may be based, at least partially, on an energy storing capability and/or an energy harvesting capability of, for example, an EH SDT UE.

In an example embodiment, a gNodeB may monitor the amount of unused, successful, and collided random access preambles and translate this into an optimal barring parameter for energy-harvesting devices. This optimal barring parameter may be specific to the low power requirements of energy-harvesting devices. In the present disclosure, the word “optimal” may be used to indicate a technical effect of maximizing energy conservation and/or minimizing delay, especially for EH devices.

In an example embodiment, a gNodeB (e.g. of serving cell 310) may estimate the number of energy-harvesting UEs that are actively waiting for transmissions, including those which unsuccessfully transmitted in the past and those waiting for their first transmission opportunity. We refer to this number of waiting devices as the backlog, and denote it by β. The backlog may be estimated from the monitoring of the random access channel and the statistics of successful UEs. Namely, the gNodeB may keep track of the number of unused, successful, and collided preambles at every random access opportunity, and may use this information to calculate a mean estimate and a confidence interval of the total number of UEs that attempted transmission at that opportunity (including successful and unsuccessful attempts), by means of a probability-theory framework. For example, a simple Bayesian approach may be as follows.

We model the number of devices attempting transmission at a given interval as the random variable Λ, the resulting number of successful transmissions as the random variable Ω, and the resulting number of collided preambles as the random variable Θ. We can compute the probability mass function of Λ after a realization of Ω and Θ as:

$$P r \{ Λ = λ \vert Ω = ω , Θ = θ \} = \frac{P r \{ Ω = ω , Θ = θ \vert Λ = λ \} Pr \{ Λ = λ \}}{{\sum }_{λ = 1}^{∞} P r \{ Ω = ω , Θ = θ \vert Λ = λ \} P r \{ Λ = λ \}}$$

where Pr{Λ=λ} is an a priori estimation of the distribution of the number of instantaneous attempts and Pr{Ω=ω,Θ=θ|Λ=λ} is the probability of obtaining ω successful transmissions and θ collisions with λ attempting devices. The latter probability can be straightforwardly obtained from the literature. Then, for each slot, the increment in the backlog β can be obtained by scaling λ by the known barring factor and re-adding the number of collided devices λ-ω. This may be done continuously for every time slot to have an updated estimation of the backlog β.

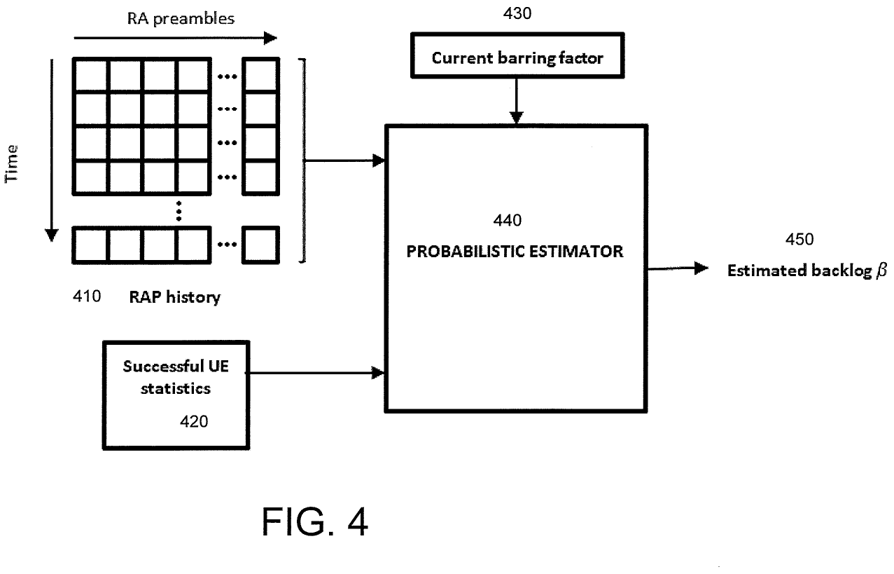

This estimation may be combined with the currently applied barring factor and the distribution of maximum number of transmission attempts that the energy-harvesting UEs that support SDT can afford in order to obtain the final estimate of the backlog. Referring now to FIG. 4, illustrated is a diagram of backlog estimation showing the inputs and outputs of this estimation. The RAP history (410) may comprise a plurality of RA preambles received from various UEs over time. Based on the RAP history (410), the successful UE statistics (420), and the current barring factor (430), a gNodeB may use a probabilistic estimator (440) to determine an estimated backlog β (450).

Once the backlog is computed, the optimal barring factor for the overall network may be optimally computed, for example:

$$OptBarrFactor = \frac{M}{β}$$

where M is the number of available preambles. It may be noted that the optimal barring factor may be “optimal” in the sense that it may have the technical effect of maximizing energy conservation and/or minimizing delay, especially for EH devices. We denote this optimal barring factor as OptBarrFactor. Finally, the final barring parameter EHSDTBarrParam is computed, with “S” average number of transmissions an EH device can afford, as follows:

$$EHSDTBarrParam = \frac{OptBarrFactor}{S}$$

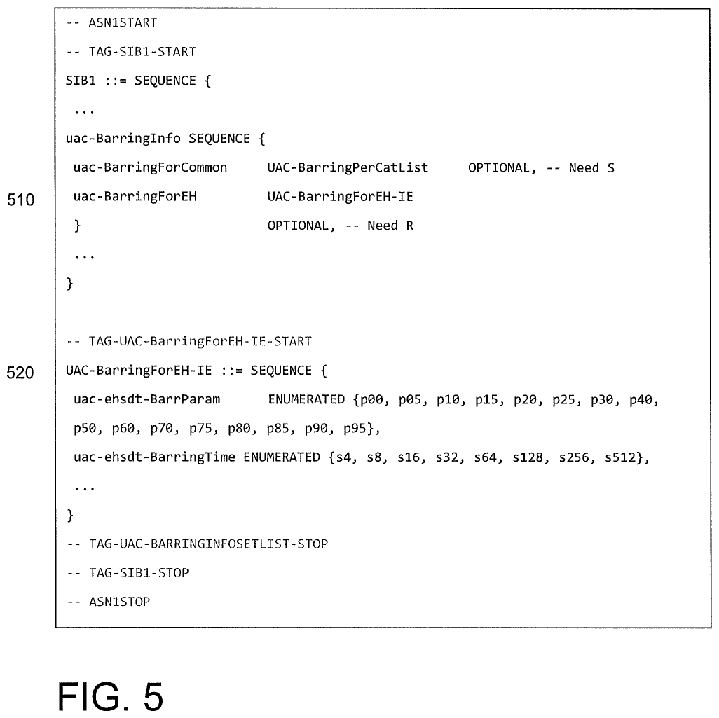

In an example embodiment, the energy-harvesting barring parameter may be broadcasted in system information, along with the remaining parameters required to find and transmit in the random access channel. It may be noted that the energy-harvesting barring parameter may not be received by non-EH devices. In other words, the energy harvesting barring parameter may be transmitted to EH devices only. Referring now to FIG. 3, at 330, the serving cell 330 may broadcast/transmit SIB1 to the energy harvesting SDT UE 305. The SIB1 may include uac-ehsdt-BarrParam and uac-ehsdt-BarringTime parameters. Remaining 5G UAC parameters may also be included in SIB1. Referring now to FIG. 5, illustrated is an example of the SIB1. At 510, uac-BarringForEH is included in the uac-BarringInfo sequence. At 520, the UAC-BarringForEH-IE sequence includes uac-ehsdt-BarrParam and uac-ehsdt-BarringTime.

In an example embodiment, the energy-harvesting UEs may implement a procedure for deciding whether they should transmit or not; the procedure may be directly influenced by their estimated number of remaining transmission attempts. As a result, the random access procedure may be dependent on the battery level of the UE.

When the UE is in a RRCInactive state and receives data to be transmitted to the network from the upper layers, it may first select a cell, synchronize to it, and retrieve its system information, as described in current specifications. Then, it may check the current energy level of its battery, and produce an estimation of the maximum number of consecutive preamble transmissions it can afford before depleting its battery, while also reserving enough energy to transmit Msg3 in case of an eventual successful transmission. This estimation may be performed using statistics from previous transmissions, or using a dedicated power consumption model. This maximum number of transmission attempts may be denoted as nMaxEHTx. In addition, the UE may keep track of the remaining number of transmissions via the internal parameter RemEHTx.

Referring now to FIG. 3, at 340, the energy harvesting SDT UE may calculate nMaxEHTx, and may calculate/determine whether it is barred from random access. From SIB1, EHSDTBarrParam may be retrieved. This barring parameter may be used to compute the effective barring factor EffBarringFactor as follows:

$$EffBarringFactor = min ( EHSDTBarrParam \cdot RemEHTx , 1 )$$

The UE may locate the RACH as described in the specifications. Then, it may generate a random number RAND between 0 and 1. Before attempting preamble transmission, the UE may determine whether it is barred from attempting RAP. This determination may be based on RAND.

In other words, the UE may determine whether to make a transmission for a random access based on the barring parameter and the remaining number of transmission attempts.

Referring now to FIG. 3, if the EH SDT UE 305 is barred, 350, the EH SDT UE 305 may wait uac-ehsdt-BarringTime before retrying random access, 335. For example, if RAND≥EffBarringFactor, the UE may be barred, and may perform a random backoff using a waiting window as specified in uac-ehsdt-BarringTime in SIB1, following the procedure described in Sec. 5.3.14.5 in TS 38.331. In other words, the EH SDT UE may not attempt to initiate the random access procedure; the EH SDT UE may not transmit a random access preamble during a waiting period.

If the EH SDT UE 305 is not barred, 360, the EH SDT UE 305 may transmit an RRC_Resume or RRC_Establishment message to the serving cell 310, 365. The message may include nMaxEHTx, calculated at 340. In other words, the UE may report to the network, upon successful transmission, the number of maximum preamble transmissions that the UE could have afforded since the first time it had data to transmit.

If RAND<EffBarringFactor, the UE may transmit a randomly selected preamble at the next random access opportunity. Then, the UE may wait for the random access response as usual, and use the allocated uplink resources to transmit Msg3, possibly along with piggybacked user data. Then, the UE may wait for the reception acknowledgement in Msg4.

If the preamble transmission results in a collision, the UE may decrease RemEHTx by one and perform a random backoff using a waiting window as specified in uac-ehsdt-BarringTime in SIB1, following the procedure described in Sec. 5.3.14.5 in TS 38.331. While not illustrated in FIG. 3, the UE may then determine whether it is barred again, e.g. beginning at 340.

If the preamble transmission is successful, then the UE may report nMaxEHTx and proceed normally with subsequent transmissions. In other words, the UE may report the maximum number of preamble transmissions it can make during a random access procedure based on the current available energy and the estimated energy required for each transmission attempt.

In an example embodiment, energy-harvesting UEs may indicate, to the network, the maximum number of preamble transmissions they can make during a random access procedure. This number may be calculated from the current available energy and the estimated energy required for each transmission attempt.

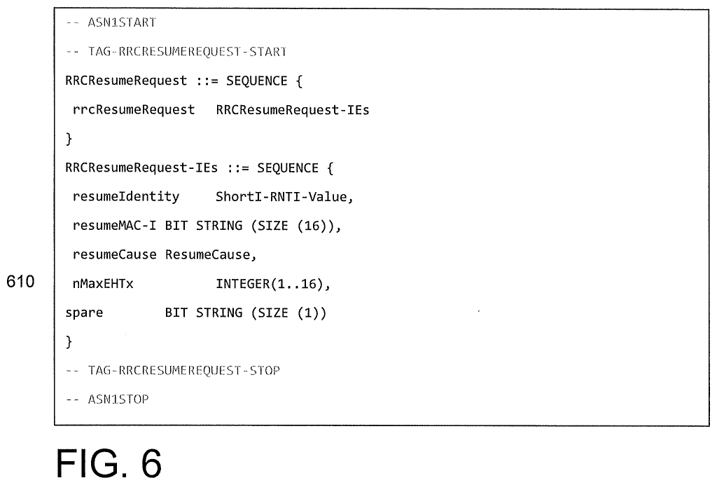

In an example embodiment, whenever there is a successful transmission of an SDT UE, the number of maximum preamble transmissions that the EH UE could have afforded since the first time it had data to transmit may be reported as a new field nMaxEHTx within the RRCResumeRequest message. Referring now to FIG. 6, illustrated is an example RRCResumeRequest message. It may be noted that nMaxEHTx (610) may be included as an integer element of a RRCResumeRequest sequence.

In an example embodiment, the value of nMaxEHTx may be the sum of previous unsuccessful attempts, the current successful transmission, a UE battery capacity, a UE energy harvesting capability during a random access procedure, and/or the remaining attempts that the UE could have afforded before running out of energy. From all successful SDT transmissions within a desired period, the gNodeB may keep (e.g. save in memory) the average of the received nMaxEHTx for its use in the subsequent estimation of the barring parameter. This average may be denoted as S in the present disclosure.

At 370, the serving cell 310 may re-estimate EH SDT load, and may set EH barring parameters based on the new load estimate.

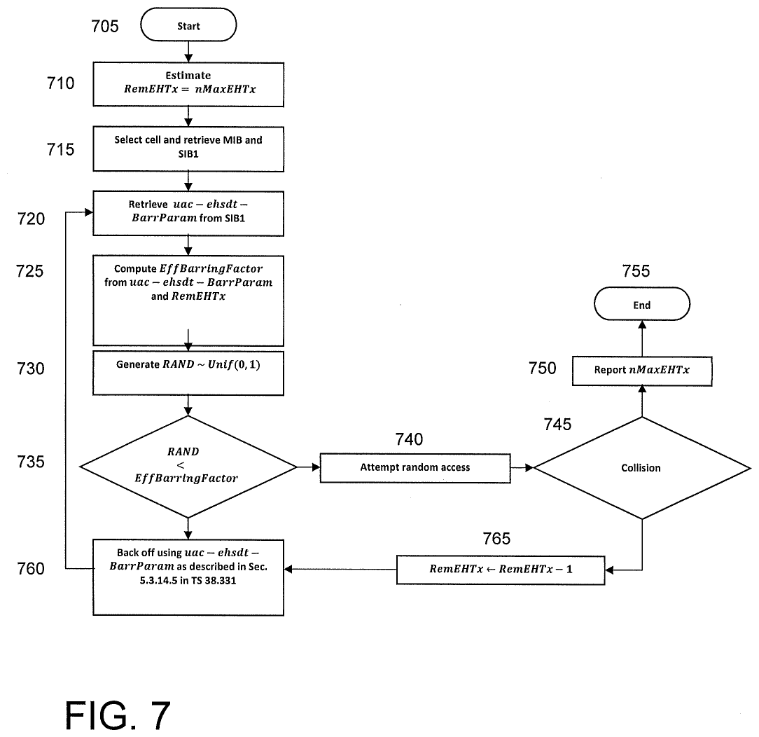

Referring now to FIG. 7, illustrated is a flow diagram summarizing an example of operation of the initial transmission of an energy-harvesting SDT UE according to an example embodiment of the present disclosure. At 705, a UE, for example an EH SDT UE, may determine that it has information to transmit to the network. At 710, the UE may estimate that RemEHTx=nMaxEHTx. In other words, the UE may estimate that the number of transmissions for which it has enough energy to perform is equal to a maximum number of transmission attempts. At 715, the UE may select a cell and retrieve MIB and SIB1. At 720, the UE may retrieve uac-ehsdt-BarrParam from SIB1. At 725, the UE may compute EffBarringFactor from uac-ehsdt-BarrParam and RemEHTx. At 730, the UE may generate a random number RAND˜Unif(0,1). At 735, the UE may compare RAND and EffBarringFactor. If RAND<EffBarringFactor, the UE may attempt random access, 740. If RAND≥EffBarringFactor, the UE may back off (i.e. not attempt random access) using uac-ehsdt-BarrParam as described in Sec. 5.3.14.5 in TS 38.331. After the back off period has expired, the UE may return to step 720.

At 745, the UE may determine whether a collision has occurred. If a collision has not occurred (i.e. RAP successful), the UE may report nMaxEHTx, 750, and perform any required transmission(s), 755. If a collision has occurred (i.e. RAP unsuccessful), the UE may decrement RemEHTx and perform back off, as at 760.

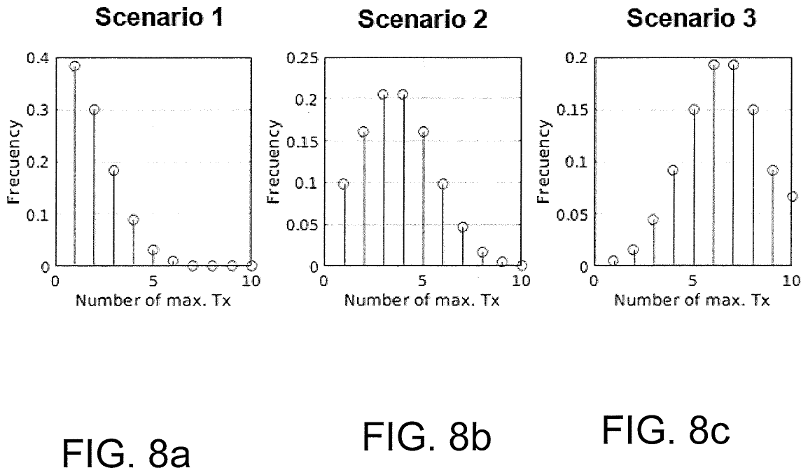

Example embodiments of the present disclosure have been evaluated via simulation of three different scenarios. Each scenario is characterized by the distribution of the UEs that can afford a certain number of transmission attempts, that is, by the distribution of nMaxEHTx. In order to cover a wide range of cases, the energy level of all UEs may be modelled via a normal distribution with configurable mean and variance, and then this energy level may be converted into a maximum number of transmission attempts. The selected nMaxEHTx distributions for the three scenarios is depicted in FIGS. 8a-8c. In each of these three scenarios, we simulate the arrival of 10,000 energy-harvesting SDT UEs within 100 random access opportunities. Depending on the configured frequency of the random access opportunities, this may correspond to a time interval between 0.1 s and 16 s. Arrivals are beta-distributed within that interval, so that they realistically mimic the simultaneous arrival of devices in a massive MTC deployment as a result of an alarm, periodic report, etc. The number of allocated SDT preambles is set to 10, out of 64 total preambles.

Three separate scenarios were investigated in simulations. These three scenarios aim to cover UEs with different energy storing and harvesting capability. In the example of FIG. 8a, there is a high frequency of UEs with a lower nMaxEHTx, e.g. 40 percent of the UEs observe 1 transmissions, i.e., nMaxEHTx=1. This scenario covers the case where a lot of UEs are with a low battery capacity. In the example of FIG. 8b, there is a high frequency of UEs with a slightly higher nMaxEHTx, e.g. a frequency of approximately 0.2 for nMaxEHTx=3 or 4. In the example of FIG. 8c, there is a high frequency of UE with a high nMaxEHTx, e.g. a frequency of approximately 0.2 for nMaxEHTx=6 or 7.

The current 5G UAC already has a method to deal with a large number of simultaneous arrivals: increasing the back-off window. This effectively flattens any arrival curve, so that the random access channel is not overloaded and preamble collisions are thus rare. However, this may unnecessarily increase the access latency for EH devices supporting SDT. Although latency is not as critical as success probability or power consumption for EH devices, it should to be taken into account, especially when comparing approaches.

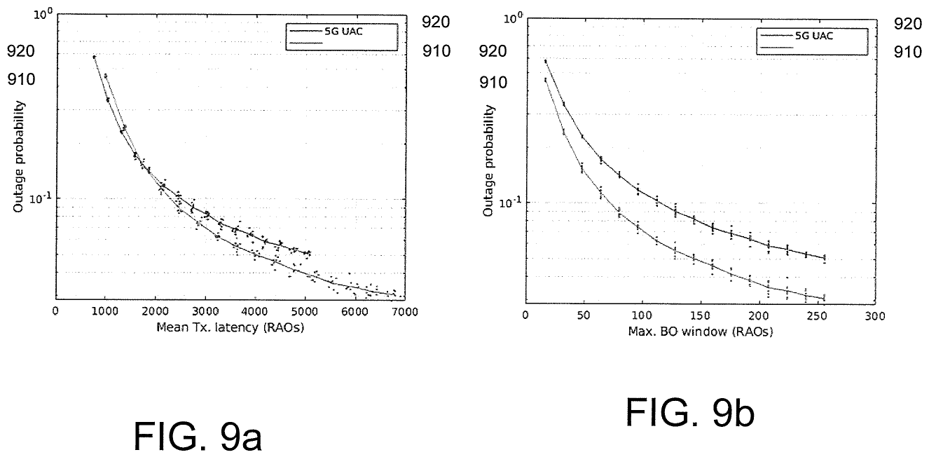

Referring now to FIG. 9a, illustrated is an outage probability for operation according to example embodiments of the present disclosure (910) in comparison to outage probability for operation according to current 5G UAC (920), as a function of actual access latency for Scenario 1 (i.e. FIG. 8a).

Referring now to FIG. 9b, illustrated is an outage probability for operation according to example embodiments of the present disclosure (910) in comparison to outage probability for operation according to current 5G UAC (920), as a function of the size of the back-off window (uac-ehsdt-BarringTime and uac-BarringTime) for Scenario 1 (i.e. FIG. 8a).

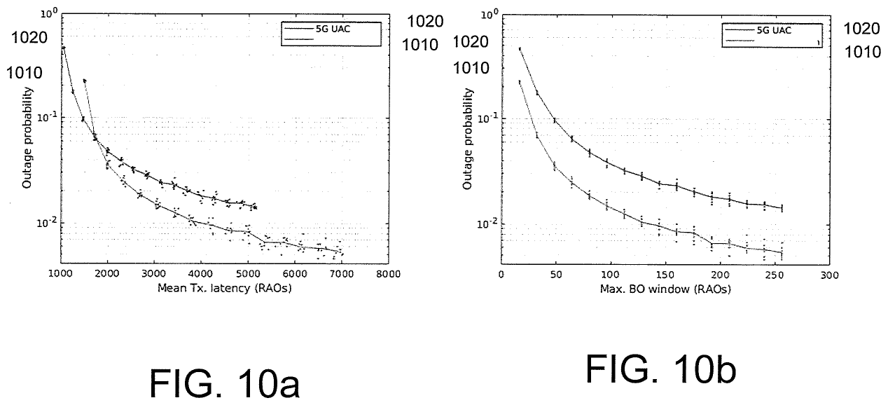

Referring now to FIG. 10a, illustrated is an outage probability for operation according to example embodiments of the present disclosure (1010) in comparison to outage probability for operation according to current 5G UAC (1020), as a function of actual access latency for Scenario 1 (i.e. FIG. 8b).

Referring now to FIG. 10b, illustrated is an outage probability for operation according to example embodiments of the present disclosure (1010) in comparison to outage probability for operation according to current 5G UAC (1020), as a function of the size of the back-off window (uac-ehsdt-BarringTime and uac-BarringTime) for Scenario 1 (i.e. FIG. 8b).

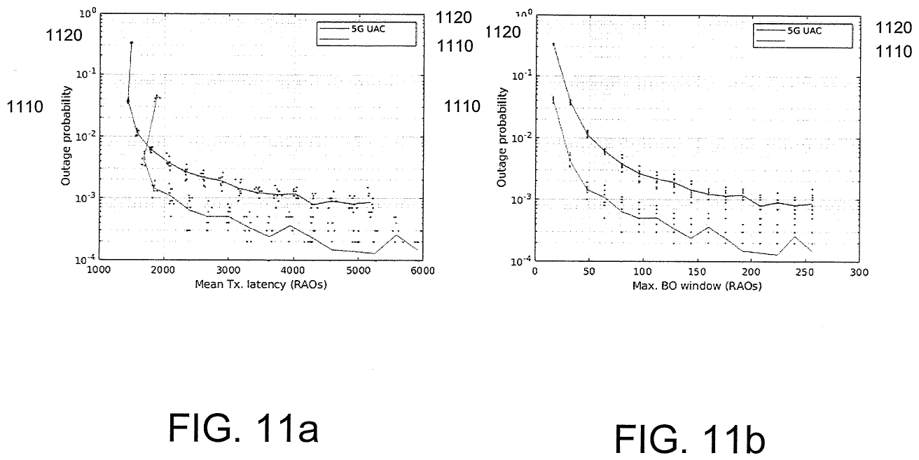

Referring now to FIG. 11a, illustrated is an outage probability for operation according to example embodiments of the present disclosure (1110) in comparison to outage probability for operation according to current 5G UAC (1120), as a function of actual access latency for Scenario 1 (i.e. FIG. 8c).

Referring now to FIG. 11b, illustrated is an outage probability for operation according to example embodiments of the present disclosure (1110) in comparison to outage probability for operation according to current 5G UAC (1120), as a function of the size of the back-off window (uac-ehsdt-BarringTime and uac-BarringTime) for Scenario 1 (i.e. FIG. 8c).

Referring now to FIGS. 9a-11b, illustrated is the outage probability, measured as the frequency of those UEs which reached their maximum number of transmission attempts without successfully transmitting for the three scenarios. It may be observed that, although the current 5G UAC does feature a way to decrease the outage probability if required, this is not as effective as example embodiments of the present disclosure. Indeed, in all three scenarios, example embodiments of the present disclosure may lead to noticeably lower outage probabilities for the same access latency (except for those trivial cases in which the outage probability is higher than 10%). For example, when the mean transmission latency is around 5000 RAOs, in Scenario 1 (FIG. 8a), example embodiments of the present disclosure lead to an outage probability of 0.04 (FIG. 9a); in Scenario 2 (FIG. 8b) this probability is around 0.008 (FIG. 10a); and in Scenario 3 (FIG. 8c) this probability is around 0.0002 (FIG. 11a). Conversely, the outage probabilities using the current 5G UAC are 0.05, 0.015, and 0.0009, respectively. In addition, it may be observed that, for the same range of back-off windows, example embodiments of the present disclosure are able to take better advantage of the latency-outage trade-off; that is, it is able to reach lower outage probabilities in exchange for additional access latency than what the current 5G UAC is able to achieve. For instance, in Scenario 2 (FIG. 8b) example embodiments of the present disclosure are able to reach an outage probability of 0.005 (FIG. 10b) whereas legacy operation can only offer up to 0.015.

Whereas 5G UAC does not provide any specific mechanism to deal with massive energy-harvesting deployments, a technical effect of example embodiments of the present disclosure may be to provide better service to this use-case. More specifically, a technical effect of example embodiments of the present disclosure may be to offer a substantially improved outage probability for massive simultaneous arrivals.

It may be noted that the changes required to implement example embodiments of the present disclosure may be easily merged with current specifications and may coexist with current 5G UAC access techniques for the rest of UEs.

A technical effect of example embodiments of the present disclosure may be to reduce the outage probability for massive simultaneous arrivals from energy harvesting devices.

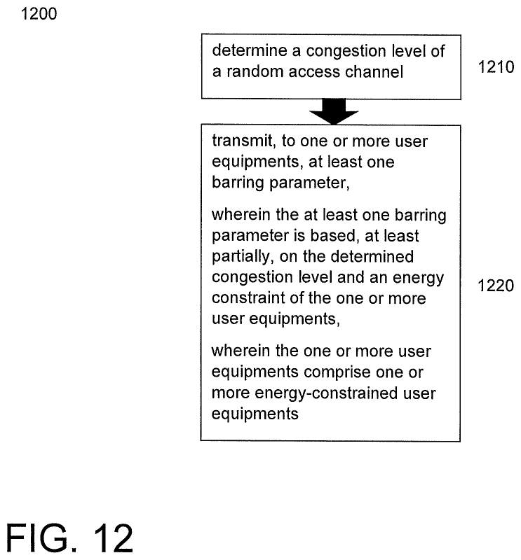

FIG. 12 illustrates the potential steps of an example method 1200. The example method 1200 may include: determining a congestion level of a random access channel, 1210; and transmitting, to one or more user equipments, at least one barring parameter, wherein the at least one barring parameter is based, at least partially, on the determined congestion level and an energy constraint of the one or more user equipments, wherein the one or more user equipments comprise one or more energy-constrained user equipments, 1220.

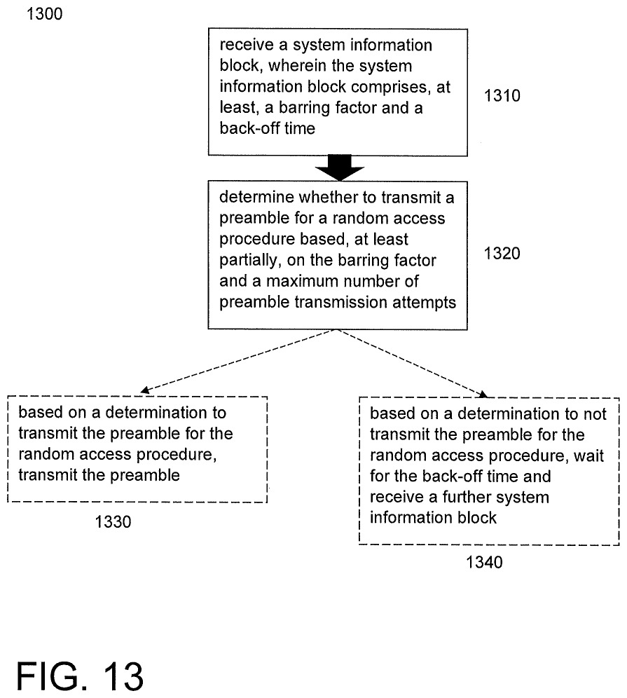

FIG. 13 illustrates the potential steps of an example method 1300. The example method 1300 may include: receiving a system information block, wherein the system information block comprises, at least, a barring factor and a back-off time, 1310; determining whether to transmit a preamble for a random access procedure based, at least partially, on the barring factor and a maximum number of preamble transmission attempts, 1320; based on a determination to transmit the preamble for the random access procedure, transmitting the preamble, 1330; and based on a determination to not transmit the preamble for the random access procedure, waiting for the back-off time and receive a further system information block, 1340.

In accordance with one example embodiment, an apparatus may comprise: at least one processor; and at least one memory including computer program code; the at least one memory and the computer program code configured to, with the at least one processor, cause the apparatus at least to: determine a congestion level of a random access channel; and transmit, to one or more user equipments, at least one barring parameter, wherein the at least one barring parameter may be based, at least partially, on the determined congestion level and an energy constraint of the one or more user equipments, wherein the one or more user equipments comprise one or more energy-constrained user equipments.

The at least one barring parameter may comprise a barring factor and a back-off time.

The congestion level may be determined based on one or more of: a number of unused random access preambles associated with the random access channel, a number of successful random access preambles associated with the random access channel, or a number of collided random access preambles associated with the random access channel.

Transmitting the at least one barring parameter may comprise the example apparatus being further configured to: include the at least one barring parameter in at least one system information block; and broadcast the at least one system information block to the one or more user equipments.

The example apparatus may be further configured to: receive, from at least one of the one or more user equipments, an indication of a maximum number of preamble transmission attempts the one or more user equipments has energy to make during a random access procedure.

The indication of the maximum number of preamble transmission attempts may be based, at least partially, on at least one of: a current available energy of the at least one user equipment, an estimated energy required for a preamble transmission of the at least one user equipment, a sum of previous unsuccess preamble transmission attempts of the at least one user equipment, a battery capacity of the at least one user equipment, or an energy harvesting capability of the at least one user equipment during the random access procedure.

The indication of the maximum number of preamble transmission attempts may be received as part of a radio resource control resume request or a radio resource control establishment request.

Determining the congestion level of the random access channel may comprise the example apparatus being further configured to: determine an average of the maximum number of preamble transmission attempts over a predetermined time period.

Determining the congestion level of the random access channel may comprise the example apparatus being further configured to: estimate a load for at least one user equipment of the one or more user equipments.

The example apparatus may be further configured to: re-estimate the load for the at least one user equipment based, at least partially, on a maximum number of preamble transmission attempts the at least one user equipment has energy to make during a random access procedure; and determine the at least one barring parameter based, at least partially, on the re-estimated load for the at least one user equipment.

Determining the congestion level of the random access channel may comprise the example apparatus being further configured to: estimate a number of the one or more user equipments that are actively waiting to transmit; determine a backlog of the random access channel based, at least partially, on: a current barring factor, a distribution of a maximum number of preamble transmission attempts the one or more user equipments have energy to make during a random access procedure, and the number of the one or more user equipments that are actively waiting to transmit; and determine the at least one barring parameter based, at least partially, on: the determined backlog, a number of available preambles for the random access procedure, and an average of the maximum number of preamble transmission attempts the one or more user equipments have energy to make during the random access procedure over a predetermined time period.

The one or more energy-constrained user equipments may comprise at least one of: one or more energy-harvesting user equipments, one or more user equipments with low battery capacity, or one or more passive user equipments without battery capacity, wherein the energy constraint of the one or more user equipments may comprise at least one of: a battery level, a battery capacity, a harvesting capacity, or a backscattering capability.

In accordance with one aspect, an example method may be provided comprising: determining a congestion level of a random access channel; and transmitting, to one or more user equipments, at least one barring parameter, wherein the at least one barring parameter may be based, at least partially, on the determined congestion level and an energy constraint of the one or more user equipments, wherein the one or more user equipments may comprise one or more energy-constrained user equipments.

In accordance with one example embodiment, an apparatus may comprise: circuitry configured to perform: determine a congestion level of a random access channel; and transmit, to one or more user equipments, at least one barring parameter, wherein the at least one barring parameter may be based, at least partially, on the determined congestion level and an energy constraint of the one or more user equipments, wherein the one or more user equipments comprise one or more energy-constrained user equipments.

In accordance with one example embodiment, an apparatus may comprise: processing circuitry; memory circuitry including computer program code, the memory circuitry and the computer program code configured to, with the processing circuitry, enable the apparatus to: determine a congestion level of a random access channel; and transmit, to one or more user equipments, at least one barring parameter, wherein the at least one barring parameter may be based, at least partially, on the determined congestion level and an energy constraint of the one or more user equipments, wherein the one or more user equipments comprise one or more energy-constrained user equipments.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: determining a congestion level of a random access channel; and transmitting, to one or more user equipments, at least one barring parameter, wherein the at least one barring parameter may be based, at least partially, on the determined congestion level and an energy constraint of the one or more user equipments, wherein the one or more user equipments may comprise one or more energy-constrained user equipments.

The at least one barring parameter may comprise a barring factor and a back-off time.

The congestion level may be determined based on one or more of: a number of unused random access preambles associated with the random access channel, a number of successful random access preambles associated with the random access channel, or a number of collided random access preambles associated with the random access channel.

The means configured to perform transmitting the at least one barring parameter may be further configured to perform: including the at least one barring parameter in at least one system information block; and broadcasting the at least one system information block to the one or more user equipments.

The means may be further configured to perform: receiving, from at least one of the one or more user equipments, an indication of a maximum number of preamble transmission attempts the one or more user equipments has energy to make during a random access procedure.

The indication of the maximum number of preamble transmission attempts may be based, at least partially, on at least one of: a current available energy of the at least one user equipment, an estimated energy required for a preamble transmission of the at least one user equipment, a sum of previous unsuccess preamble transmission attempts of the at least one user equipment, a battery capacity of the at least one user equipment, or an energy harvesting capability of the at least one user equipment during the random access procedure.

The indication of the maximum number of preamble transmission attempts may be received as part of a radio resource control resume request or a radio resource control establishment request.

The means configured to perform determining the congestion level of the random access channel may be further configured to perform: determining an average of the maximum number of preamble transmission attempts over a predetermined time period.

The means configured to perform determining the congestion level of the random access channel may be further configured to perform: estimating a load for at least one user equipment of the one or more user equipments.

The means may be further configured to perform: re-estimating the load for the at least one user equipment based, at least partially, on a maximum number of preamble transmission attempts the at least one user equipment has energy to make during a random access procedure; and determining the at least one barring parameter based, at least partially, on the re-estimated load for the at least one user equipment.

The means configured to perform determining the congestion level of the random access channel may be further configured to perform: estimating a number of the one or more user equipments that are actively waiting to transmit; determining a backlog of the random access channel based, at least partially, on: a current barring factor, a distribution of a maximum number of preamble transmission attempts the one or more user equipments have energy to make during a random access procedure, and the number of the one or more user equipments that are actively waiting to transmit; and determining the at least one barring parameter based, at least partially, on: the determined backlog, a number of available preambles for the random access procedure, and an average of the maximum number of preamble transmission attempts the one or more user equipments have energy to make during the random access procedure over a predetermined time period.

The one or more energy-constrained user equipments may comprise at least one of: one or more energy-harvesting user equipments, one or more user equipments with low battery capacity, or one or more passive user equipments without battery capacity, wherein the energy constraint of the one or more user equipments may comprise at least one of: a battery level, a battery capacity, a harvesting capacity, or a backscattering capability.

In accordance with one example embodiment, a non-transitory computer-readable medium comprising program instructions stored thereon which, when executed with at least one processor, cause the at least one processor to: determine a congestion level of a random access channel; and cause transmission, to one or more user equipments, at least one barring parameter, wherein the at least one barring parameter may be based, at least partially, on the determined congestion level and an energy constraint of the one or more user equipments, wherein the one or more user equipments may comprise one or more energy-constrained user equipments.

In accordance with another example embodiment, a non-transitory program storage device readable by a machine may be provided, tangibly embodying a program of instructions executable by the machine for performing operations, the operations comprising: determine a congestion level of a random access channel; and cause transmission, to one or more user equipments, at least one barring parameter, wherein the at least one barring parameter may be based, at least partially, on the determined congestion level and an energy constraint of the one or more user equipments, wherein the one or more user equipments may comprise one or more energy-constrained user equipments.

In accordance with one example embodiment, an apparatus may comprise: at least one processor; and at least one memory including computer program code; the at least one memory and the computer program code configured to, with the at least one processor, cause the apparatus at least to: receive a system information block, wherein the system information block may comprise, at least, a barring factor and a back-off time; determine whether to transmit a preamble for a random access procedure based, at least partially, on the barring factor and a maximum number of preamble transmission attempts; based on a determination to transmit the preamble for the random access procedure, transmit the preamble; and based on a determination to not transmit the preamble for the random access procedure, wait for the back-off time and receive a further system information block.

The example apparatus may be further configured to: estimate the maximum number of preamble transmission attempts based, at least partially, on at least one of: a current available energy, an estimated energy required for a preamble transmission, a sum of previous unsuccessful preamble transmission attempts, a battery capacity, or an energy harvesting capability during the random access procedure.

The estimated energy required for the preamble transmission further may comprise energy required to transmit a message two of the random access procedure.

The estimated energy required for the preamble transmission may be determined based, at least partially, on a dedicated power consumption model.

Transmitting the preamble may comprise the example apparatus being further configured to: transmit the maximum number of preamble transmission attempts as part of a radio resource control resume request or a radio resource control establishment request.

Receiving the system information block may comprise the example apparatus being further configured to: select a network cell; perform synchronization with the network cell; and receive the system information block from the network cell.

The example apparatus may be further configured to: determine a current remaining number of preamble transmission attempts.

Determining whether to transmit the preamble for the random access procedure may comprise the example apparatus being further configured to: determine an effective barring parameter based, at least partially, on the barring factor and the current remaining number of preamble transmission attempts; generate a random number between zero and one; and compare the random number and the effective barring parameter, wherein the determination to transmit the preamble for the random access procedure may comprise the random number being less than the effective barring parameter, wherein the determination to not transmit the preamble for the random access procedure may comprise the random number being greater than or equal to the effective barring parameter.

The example apparatus may be further configured to: determine that the transmitted preamble results in a collision; decrease the effective barring parameter by one; wait for the back-off time; and receive a third system information block.

The example apparatus may be in a radio resource control inactive state or a radio resource control idle state.

The example apparatus may comprise at least one of: an energy-constrained user equipment, an energy-harvesting user equipment, a user equipment with low battery capacity, or a user equipment without battery capacity, wherein an energy constraint of the apparatus comprises at least one of: a battery level, a battery capacity, a harvesting capacity, or a backscattering capability.

In accordance with one aspect, an example method may be provided comprising: receiving a system information block, wherein the system information block may comprise, at least, a barring factor and a back-off time; determining whether to transmit a preamble for a random access procedure based, at least partially, on the barring factor and a maximum number of preamble transmission attempts; based on a determination to transmit the preamble for the random access procedure, transmitting the preamble; and based on a determination to not transmit the preamble for the random access procedure, waiting for the back-off time and receiving a further system information block.

In accordance with one example embodiment, an apparatus may comprise: circuitry configured to perform: receive a system information block, wherein the system information block may comprise, at least, a barring factor and a back-off time; determine whether to transmit a preamble for a random access procedure based, at least partially, on the barring factor and a maximum number of preamble transmission attempts; based on a determination to transmit the preamble for the random access procedure, transmit the preamble; and based on a determination to not transmit the preamble for the random access procedure, wait for the back-off time and receive a further system information block.

In accordance with one example embodiment, an apparatus may comprise: processing circuitry; memory circuitry including computer program code, the memory circuitry and the computer program code configured to, with the processing circuitry, enable the apparatus to: receive a system information block, wherein the system information block may comprise, at least, a barring factor and a back-off time; determine whether to transmit a preamble for a random access procedure based, at least partially, on the barring factor and a maximum number of preamble transmission attempts; based on a determination to transmit the preamble for the random access procedure, transmit the preamble; and based on a determination to not transmit the preamble for the random access procedure, wait for the back-off time and receive a further system information block.

In accordance with one example embodiment, an apparatus may comprise means for performing: receiving a system information block, wherein the system information block may comprise, at least, a barring factor and a back-off time; determining whether to transmit a preamble for a random access procedure based, at least partially, on the barring factor and a maximum number of preamble transmission attempts; based on a determination to transmit the preamble for the random access procedure, transmitting the preamble; and based on a determination to not transmit the preamble for the random access procedure, waiting for the back-off time and receiving a further system information block.

The means may be further configured to perform: estimating the maximum number of preamble transmission attempts based, at least partially, on at least one of: a current available energy, an estimated energy required for a preamble transmission, a sum of previous unsuccessful preamble transmission attempts, a battery capacity, or an energy harvesting capability during the random access procedure.

The estimated energy required for the preamble transmission may further comprise energy required to transmit a message two of the random access procedure.

The estimated energy required for the preamble transmission may be determined based, at least partially, on a dedicated power consumption model.

The means configured to perform transmitting the preamble may be further configured to perform: transmitting the maximum number of preamble transmission attempts as part of a radio resource control resume request or a radio resource control establishment request.

The means configured to perform receiving the system information block may be further configured to perform: selecting a network cell; performing synchronization with the network cell; and receiving the system information block from the network cell.

The means may be further configured to perform: determining a current remaining number of preamble transmission attempts.

The means configured to perform determining whether to transmit the preamble for the random access procedure may be further configured to perform: determining an effective barring parameter based, at least partially, on the barring factor and the current remaining number of preamble transmission attempts; generating a random number between zero and one; and comparing the random number and the effective barring parameter, wherein the determination to transmit the preamble for the random access procedure may comprise the random number being less than the effective barring parameter, wherein the determination to not transmit the preamble for the random access procedure may comprise the random number being greater than or equal to the effective barring parameter.

The means may be further configured to perform: determining that the transmitted preamble results in a collision; decreasing the effective barring parameter by one; waiting for the back-off time; and receiving a third system information block.

The example apparatus may be in a radio resource control inactive state or a radio resource control idle state.

The example apparatus may comprise at least one of: an energy-constrained user equipment, an energy-harvesting user equipment, a user equipment with low battery capacity, or a user equipment without battery capacity, wherein an energy constraint of the apparatus comprises at least one of: a battery level, a battery capacity, a harvesting capacity, or a backscattering capability.

In accordance with one example embodiment, a non-transitory computer-readable medium comprising program instructions stored thereon which, when executed with at least one processor, cause the at least one processor to: receive a system information block, wherein the system information block may comprise, at least, a barring factor and a back-off time; determine whether to transmit a preamble for a random access procedure based, at least partially, on the barring factor and a maximum number of preamble transmission attempts; based on a determination to transmit the preamble for the random access procedure, cause transmitting of the preamble; and based on a determination to not transmit the preamble for the random access procedure, wait for the back-off time and receive a further system information block.

In accordance with another example embodiment, a non-transitory program storage device readable by a machine may be provided, tangibly embodying a program of instructions executable by the machine for performing operations, the operations comprising: receive a system information block, wherein the system information block may comprise, at least, a barring factor and a back-off time; determine whether to transmit a preamble for a random access procedure based, at least partially, on the barring factor and a maximum number of preamble transmission attempts; based on a determination to transmit the preamble for the random access procedure, cause transmitting of the preamble; and based on a determination to not transmit the preamble for the random access procedure, wait for the back-off time and receive a further system information block.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1.-50. (canceled)

51. An apparatus comprising:
at least one processor; and
at least one non-transitory memory including computer program code;
the at least one memory and the computer program code configured to, with the at least one processor, cause the apparatus at least to:
receive a system information block, wherein the system information block comprises, at least, a barring factor and a back-off time;
determine whether to transmit a preamble for a random access procedure based, at least partially, on the barring factor and a maximum number of preamble transmission attempts;
based on a determination to transmit the preamble for the random access procedure, transmit the preamble; and
based on a determination to not transmit the preamble for the random access procedure, wait for the back-off time and receive a further system information block.
